(19) United States
(12) Patent Application Publication
(10) Pub. No.: US 2025/0244999 A1
(43) Pub. Date: Jul. 31, 2025

(54) STORAGE RESOURCES SAVING MANAGEMENT OF ARTIFACT INFORMATION PACKAGES, SUCH AS PACKAGES RELATING TO DIFFERENT DEVELOPMENT BRANCHES OF AN APP, METHOD, AND SYSTEM

(71) Applicant: Mendix Technology B.V., Rotterdam (NL)

(72) Inventor: Sean Ryan, Den Haag (NL)

(21) Appl. No.: 18/429,092

(22) Filed: Jan. 31, 2024

(51) Int. Cl. G06F 8/71; G06F 8/34

(52) U.S. Cl. CPC G06F 8/71; G06F 8/34

(57) ABSTRACT

A method includes providing a sequence of artifact information packages including an earliest package and a latest package in a data repository. Each package except the earliest package is an amended version of the respective preceding package. The sequence includes at least three branches of packages, including a main branch including the latest package. The branches include at least two side branches of which a respective earliest branch package is a respective amended version of a preceding package of the main branch. Cut-off information separating the packages in pre-cut-off packages and post-cut-off packages is provided. At least one of the side branches including at least one post-cut-off package to be a respective retained side branch is determined, a part of the earliest package is stored in a data store, and the respective post-cut-off package of the respective side branch other than the respective retained side branch is discarded.

### TECHNICAL FIELD

The present disclosure is directed, in general, to software management systems, and, more particularly, to systems for distributed version control that track changes in any set of computer files. Further, such software management systems may be used for developing apps, such as including managing, building, testing, deploying, and iterating such apps (collectively referred to herein as product systems).

### BACKGROUND

The present embodiments generally relate to the management of artifact information packages, such as packages relating to different development branches of an app.

Recently, software is often developed collaboratively by many programmers leading to many branches of the software during the development. Branches include many artifact information packages, and storing these numerous artifact information packages consumes large data storage resources. Further, an increasing number of computer software products is used both for personal needs and for business needs in the form of applications (throughout the present patent document, simply referred to as “apps”). Such apps may be used in a mobile context as well as on cloud computing platforms and “on premise,” and may provide a specific set of functions.

Currently, there exist product systems and solutions that support management of artifact information packages. Such product systems may benefit from improvements.

### SUMMARY AND DESCRIPTION

Variously disclosed embodiments include methods and computer systems that may be used to facilitate managing artifact information packages.

Variously disclosed embodiments include methods and computer systems that may be used to facilitate managing an app.

According to a first aspect of the present embodiments, a computer-implemented method may include: providing a sequence of artifact information packages including an earliest package and a latest package in a data repository, wherein each package except the earliest package is an amended version of the respective preceding package, wherein the sequence further includes at least three branches of packages including a main branch, the main branch including the latest package, and wherein the branches further include at least two side branches of which a respective earliest branch package is a respective amended version of a preceding package of the main branch; providing cut-off information separating the packages in pre-cut-off packages and post-cut-off packages; determining at least one of the side branches including at least one post-cut-off package to be a respective retained side branch; storing at least a part of the earliest package in a data store; and discarding the respective post-cut-off package of the respective side branch other than the respective retained side branch.

According to a second aspect of the present embodiments, a computer system may be arranged and configured to execute the acts of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 depicts a functional block diagram of a first example system that facilitates managing artifact information packages in a product system.

FIG. 2 depicts a flow diagram of an example software development process including different branches with artifact information packages that are managed by the first example system.

FIG. 3 depicts a functional block diagram of a second example system that facilitates managing artifact information packages in a product system.

FIG. 4 depicts a flow diagram of another example software development process including different branches with artifact information packages that are managed by the second example system.

FIG. 5 depicts a functional block diagram of a third example system that facilitates app development and managing artifact information packages in a product system.

FIG. 6 depicts a flow diagram of an example methodology that facilitates managing artifact information packages in a product system.

FIG. 7 depicts a block diagram of a data processing system in which an embodiment may be implemented.

### DETAILED DESCRIPTION

Various technologies that pertain to systems and methods for storage resources saving management of artifact information packages, such as packages relating to different development branches of an app, in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for example, an element may be configured to perform functionality that is described as being carried out by multiple elements. The numerous innovative teachings of the present patent document will be described with reference to non-limiting embodiments.

First, some concepts of collaboratively developed software are introduced.

In software development, distributed version control (also known as distributed revision control) is a form of version control in which the complete codebase, including its full history, is mirrored on every developer's computer. Compared to centralized version control, this enables automatic management branching and merging, speeds up most operations (e.g., except pushing and pulling), improves the ability to work offline, and does not rely on a single location for backups. Git, the world's most popular version control system, is a distributed version control system.

Herein, Git tracks changes in any set of computer files, usually used for coordinating work among programmers who are collaboratively developing source code during software development. Its goals include speed, data integrity, and support for distributed, non-linear workflows (e.g., thousands of parallel branches running on different computers).

Branching, in version control and software configuration management, is the duplication of an object under version control (e.g., a source code file or a directory tree). Each object may thereafter be modified separately and in parallel so that the objects become different. In this context, the objects are referred to as branches. The users of the version control system may branch any branch. Branches are also known as trees, streams, or codelines. The originating branch may be referred to as the parent branch, the upstream branch (or simply upstream, especially if the branches are maintained by different organizations or individuals), or the backing stream. Child branches are branches that have a parent; a branch without a parent is referred to as the trunk or the mainline. The trunk may also be loosely referred to as HEAD; however, properly, head refers not to a branch, but to the most recent commit on a given branch, and both the trunk and each named branch has its own head. The trunk may be the base of a project on which development progresses. If developers are working exclusively on the trunk, the trunk always contains the latest cutting-edge version of the project, but, therefore, may also be the most unstable version. Another approach is to split a branch off the trunk, implement changes in that branch, and merge the changes back into the trunk when the branch has proven to be stable and working. Depending on development mode and commit policy, the trunk may contain the most stable or the least stable or something-in-between version. Other terms for trunk include baseline, mainline, and master, though in some cases, these are used with similar but distinct senses. Often, main developer work takes place in the trunk, and stable versions are branched; occasional bug-fixes are merged from branches to the trunk. When development of future versions is done in non-trunk branches, the development may be done for projects that do not change often, or where a change is expected to take a long time to develop, until it will be ready for incorporating in the trunk.

Further, in computer science and data management, a commit is the making of a set of tentative changes permanent, marking the end of a transaction and providing Durability to ACID (atomicity, consistency, isolation, durability) transactions. A commit is an act of committing. The record of commits is referred to as the commit log. In terms of transactions, the opposite of commit is to discard the tentative changes of a transaction, a rollback.

These elementary concepts of collaboratively developed software may also be applied in the context of app development of which elementary concepts are introduced below.

An app generally refers to a software program that, on execution, performs specific desired tasks. In general, a number of apps are executed in a runtime environment containing one or more operating systems (“OSs”), virtual machines (e.g., supporting Java™ programming language), device drivers, etc.

Apps, including native apps, may be created, edited, and represented using traditional source code. Examples of such traditional source code include C, C++, Java, Flash, Python, Perl, and other script-based methods of representing an app. Developing, creating, and managing such script-based apps, or parts of such script-based apps may be accomplished by manual coding of suitably trained users.

Developers often use Application Development Frameworks (“ADFs”) (which are by themselves applications or apps) for implementing/developing desired apps. An ADF provides a set of pre-defined code/data modules that may be directly/indirectly used in the development of an app. An ADF may also provide tools such as an Integrated Development Environment (“IDE”), code generators, debuggers, etc. that facilitate a developer in coding/implementing the desired logic of the app in a faster/simpler manner.

In general, an ADF simplifies app development by providing reusable components that may be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps may also be created, edited, and represented using visual model-based representations. Unlike traditional source code implementations, such apps may be created, edited, and/or represented by drawing, moving, connecting, and/or disconnecting visual depictions of logical elements within a visual modeling environment. Visual model-based representations of apps may use symbols, shapes, lines, colors, shades, animations, and/or other visual elements to represent logic, data, or memory structures or user interface elements. In order to program a traditional script-based app, programmers are typically required to type out detailed scripts according to a complicated set of programming syntax rules. In contrast, programming a visual model-based app may, in some cases, be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app may be done by drawing, placing, or connecting visual depictions of logical elements within a virtual workspace, as opposed to typing out detailed commands in a script. Visual-model based apps, including native apps, may therefore be more intuitive to program and/or edit compared to traditional script-based apps. In the present document, an approach is suggested to manage apps, such as to create an app including to develop a user interface of the app, which may involve the explained visual model-based representations.

For brevity, references to a “model,” a “visual model,” or an “application” or “app” may refer to visual model-based apps, including native apps, unless specifically indicated. In some cases, such visual model-based apps may represent complete, stand-alone apps for execution on a computer system. Visual model-based apps may also represent discrete modules that are configured to perform certain tasks or functions, but do not represent complete apps; instead, such discrete modules may be inserted into a larger app or combined with other discrete modules to perform more complicated tasks. Examples of such discrete modules may include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app may receive, what outputs an app may provide, the algorithms and operations by which the app may arrive at results, what data the app may display, what data the app may store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but are not designed to be compiled or executed. These visual representations may include, for example, flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail; for example, users may display or hide branches of logic, and/or display or hide sets of parameters. Details relating to an element of the visual model may be hidden from view by default but may appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if the model were displayed within a modeling environment. In other words, the visual representation may be configured to mimic how the model would appear if the model were displayed within a visual modeling environment. A single internal representation may correspond to multiple visual representations that use different styles or formatting rules to display app logic. For example, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people may contribute to the app's development, not only those with formal programming skills. Low-code app development platforms may also lower the initial cost of setup, training, deployment, and maintenance.

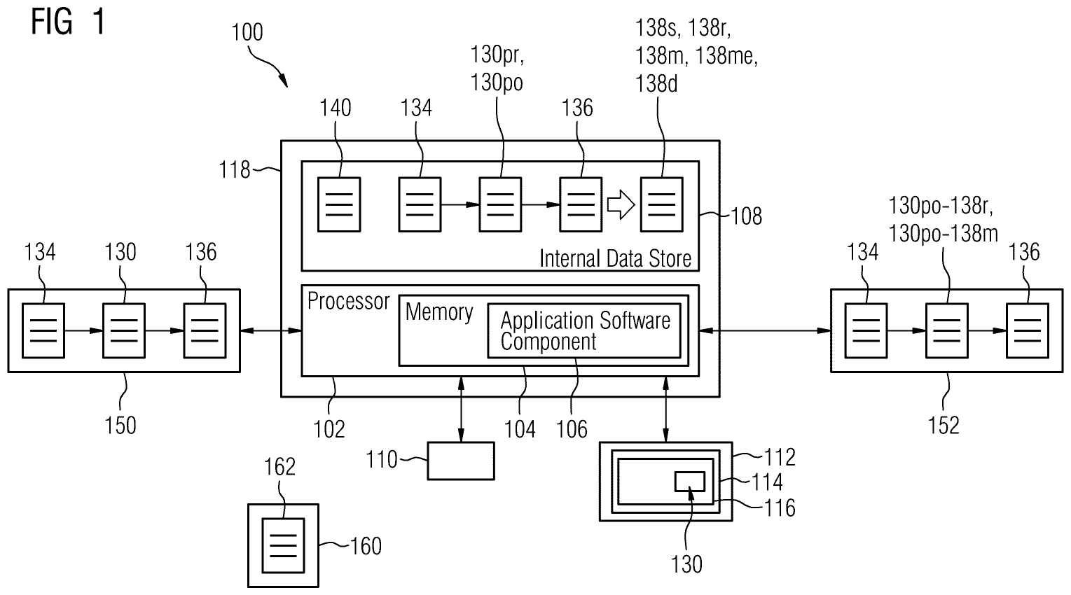

With reference to FIG. 1, a functional block diagram of an example computer system or data processing system 100 that facilitates managing artifact information packages 130, such as packages 130 relating to different development branches 138 of an app 120, is depicted. The processing system 100 may include an artifact development platform 118 that may, in some examples, be an app development platform 118 (e.g., visual model-based app development platform). The artifact development platform 118 may include at least one processor 102 that is configured to execute at least one application software component 106 from a memory 104 accessed by the processor 102. Herein, the artifact development platform 118 may include the above-described functionalities of distributed version control and optionally of visual model-based representations, visual model-based apps, and/or visual models. By way of example, the artifact development platform 118 may be a visual model-based app development platform or a low-code app development platform that supports the above-described functionalities of distributed version control. The application software component 106 may be configured (e.g., programmed) to cause the processor 102 to carry out various acts and functions described herein. For example, the described application software component 106 may include and/or correspond to one or more components of an application for managing artifact information packages 130 that is configured to generate and store product data in a data store 108 such as a database. Further, the described application software component 106 may include and/or correspond to one or more components of an app creation or development application.

By way of example, the artifact development platform 118 may be cloud-based, internet-based, and/or be operated by a provider providing support for developing, creating, and storing artifact information packages. Optionally, the artifact development platform 118 may further support app development and creation support, including, for example, supporting low-code and/or visual model-based app development. The user may be located close to the artifact development platform 118 or remote to the artifact development platform 118 (e.g., anywhere else, such as using a mobile device for connecting to the artifact development platform 118, such as via the internet). The mobile device may include an input device 110 and a display device 112. In some examples, the artifact development platform 118 may be installed and run on a user's device, such as a computer, laptop, pad, on-premises computing facility, or the like.

Examples of product systems that may be adapted to include the management of artifact information packages features described herein may include the above-mentioned Git, which may, for example, be used cloud- or internet-based or may be installed and run on a user's device, such as a computer, laptop, pad, on-premises computing facility, or the like, as already mentioned above.

Examples of product systems that may be adapted to include the management of packages 130 relating to different development branches 138 of an app 120 (e.g., app management and/or development, such as for creating an app 120) may include the low-code software development platform of Mendix Inc., of Boston, Massachusetts, USA. This platform provides tools to build, test, deploy, iterate, develop, create, and manage apps 120 and is based on visual, model-driven software development.

It should, however, be appreciated that the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server applications such as Oracle, Microsoft SQL Server, or any other type of data store that is operative to store data records.

It should be appreciated that it may be difficult and time-consuming to manage artifact information packages 130, such as packages 130 relating to different development branches 130 of an app 120, in complex artifact development and/or management environments. For example, advanced coding, software, or distributed version control knowledge of users may be required, or selections of many options are to be made consciously, each involving many manual steps, which is a long and not efficient process. This may particularly be the case if, in some examples, storage resources for storing the artifact information packages 130 shall be saved while preserving a meaningful recent history or branch and inter-branch structure that may be helpful for ongoing and future development of the packages 130 and optionally of the app 120. Hence, one challenge may, for example, be to reduce the size of a git repository whilst preserving meaningful recent information on relevant branches 138 or artifact information packages 130.

To enable the enhanced management of artifact information packages 130, such as packages 130 relating to different development branches 138 of an app 120, the described product system or processing system 100 may include at least one input device 110 and at least one display device 112 (e.g., a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause managing the artifact information packages 130, and, optionally, developing the app 120. By way of example, the GUI 114 may include an artifact development UI 116 provided to a user for managing the artifact information packages 130 and optionally developing the app 120.

In an example embodiment, the application software component 106 and/or the processor 102 may be configured to provide a sequence 132 of artifact information packages 130 including an earliest package 134 and a latest package 136 in a data repository 150, where each package 130 except the earliest package 134 is an amended version of the respective preceding package 130. The sequence 132 further includes at least three branches 138 of packages 130 including a main branch 138m. The main branch 138m includes the latest package 136. The branches 138 further include at least two side branches 138s of which a respective earliest branch package 134s is a respective amended version of a preceding package 130 of the main branch 138m.

In some examples, sequence 132 of artifact information packages 130 that may be organized in branches 138 may be developed collaboratively by a plurality of developers. Herein, a package 130 may, for example, include one or more commits that may correspond to a set of tentative changes made to the artifact information of the previous package 130 permanent to create a subsequent package 130 of the sequence 132. The package 130 or the commit may, in some examples, include or point to one or more binary files that may sometimes be known as blobs (binary large objects). Herein, generally, a blob may store data for a file.

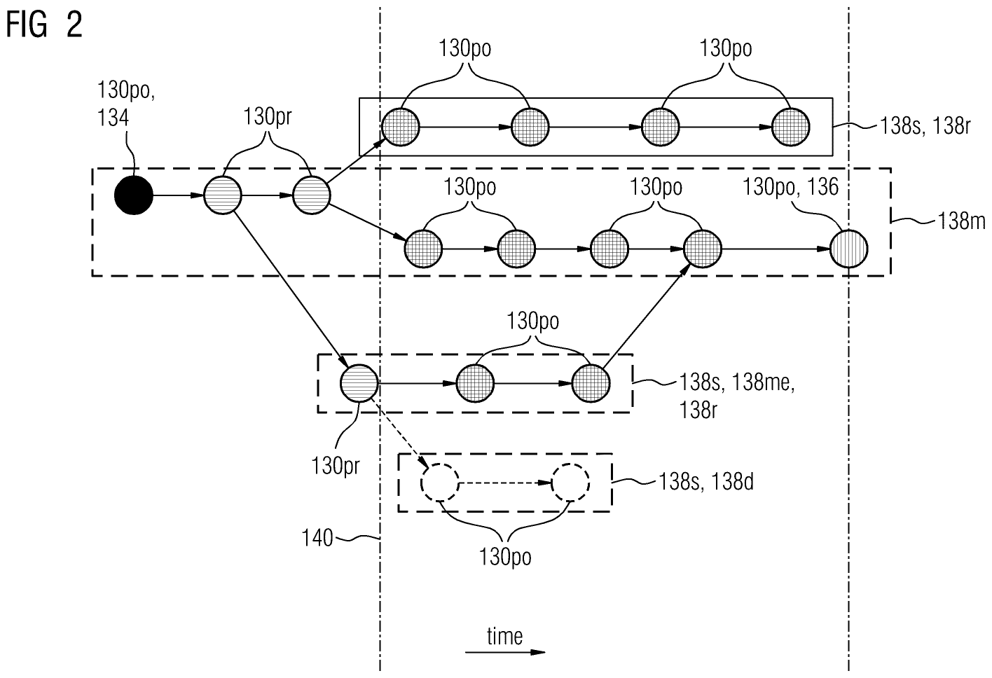

The sequence 132 may include the earliest package 132 and the latest package 136 that define the main branch 138m. As briefly mentioned above, the latest package 136 may sometimes be referred to as “head”. Further, the sequence may have side branches 138s, where a side branch 138s starts with a duplicated package 130 of the main branch 138m that is then amended by the developer(s) and stored in parallel to the main branch 138m, which also includes an amended version of the duplicated package 130. In some examples, side branches 138 may also be branched off from side branches 138s according to an analogous procedure. Reference is made to FIG. 2, which depicts an example flow diagram including different branches 138 with artifact information packages 130 and the corresponding description below.

In some examples, providing the sequence 132 of artifact information packages 130 in the repository 150 may involve that one or more developers develop the sequence 132 and store the sequence in the repository 150. In further examples, the repository 150 may receive the sequence 132, for example, via an application programming interface (API) from another data source or via an artifact app development user interface (UI) 116 from one or more developers. The repository 150 may then provide the stored sequence 132 to one or more users of the artifact development platform 118 for the suggested management of artifact information packages 130.

In some examples, the application software component 106 and/or the processor 102 may further be configured to provide cut-off information 140 separating the packages 130 in pre-cut-off packages 130pr and post-cut-off packages 130po.

The cut-off information 140 may, in some examples, be provided as a point of time or a time span (e.g., Jan. 1, 2024 or three months). When executing the suggested method of managing of packages 130, the cut-off information 140 may work such that the packages 130 of the sequence 132 may be separated in pre-cut-off packages 130pr that have been created, stored, or committed before Jan. 1, 2024 or earlier than three months ago, and in post-cut-off packages 130po that have been created, stored, or committed after Jan. 1, 2024 or in the last three months. Herein, a suitable cut-off 140 may, in some examples, depend on the team of developers or the software development project (e.g., its complexity or its release cycle or release frequency). Further, it should be appreciated that, in some examples, the shorter the time span related with the cut-off information 140, the larger the data compression, which provides that fewer data storage resources are required for storing the retained elements of the sequence 132.

In some examples, providing the cut-off information 140 may involve that one or more developers or other involved personas define or select a suitable cut-off 140 and store the corresponding cut-off information 140 (e.g., in the data store 108 or the repository 150). The storage of the cut-off information 140 may, for example, be done via an API or the artifact development UI 116, as already explained above in the context of the provision of the sequence 132. The data store 108 or the repository 150 may then provide the stored cut-off information 140 to the artifact development platform 118 for the suggested management of artifact information packages 130.

In further examples, the application software component 106 and/or the processor 102 may further be configured to determine at least one of the side branches 138s including at least one post-cut-off package 130po to be a respective retained side branch 138r.

In some examples, the determination of the respective retained side branch 138r may be done by identifying one or more of the side branches 130s that are to be retained. Herein, the respective retained side branch 138r or the respective post-cut-off package 130po of the respective retained side branch 138r may, for example, be considered to be an interesting side branch 138s or an interesting post-cut-off package 130po, respectively. The interest may, for example, relate to the relevance of such an interesting side branch 138s or such an interesting post-cut-off package 130po to ongoing and future development of the packages 130 and optionally of the app 120. In further examples, the determination of the respective retained side branch 138r may conversely be done by identifying one or more of the side branches 138s that are to be discarded so that the other side branch(s) 138s (e.g., which are therefore not to be discarded) are to be retained. The determination of the respective retained side branch 138r may, for example, be supported by the user by interacting with the artifact development UI 116. The sequence 132 or at least a part of the sequence 132 may, for example, be displayed to the user via the artifact development UI 116. The user may provide user input indicative of selecting one or more of the side branches 138s to be retained and/or conversely selecting one or more of the side branches 138s to be discarded.

Further examples of determining the respective retained side branch 130r are provided below. By way of example, at least one of the side branches 138s including at least one post-cut-off package 130po is not to be retained but to be discarded, as will also be explained in more detail below.

By way of example, the application software component 106 and/or the processor 102 may further be configured to store at least a part of the earliest package 134 in a data store 108, 152.

In some examples, the earliest package 134 or at least a part of the earliest package 134 may be stored in the data store 108 of the artifact development platform 108 or in a data store that is separate from the artifact development platform 108. In further examples, the entire earliest package 134 is stored in the data store 108, 152. In other examples, only a part of the earliest package 134 is stored in the data store 108, 152, where more details on which parts of the earliest package 134 may be stored are provided below.

In some examples, storing at least a part of the earliest package 134 in the data store 108, 152 may contribute to preserve a meaningful history or branch and inter-branch structure that may be helpful for ongoing and future development of the packages 130 and optionally of the app 120. This may, for example, be the case if the earliest package 134 includes artifact information or at least one file that is not amended in the course of the artifact development process and is therefore still relevant to the latest package 136.

By way of example, the respective part of the earliest package 134 that is stored in the data store 108, 152 may further be stored in the repository 150 (e.g., replacing the earliest package 134 that was initially stored in the repository 150 and provided to the artifact development platform 118 for the suggested management of the artifact information packages 130).

In further examples, the application software component 106 and/or the processor 102 may further be configured to discard the respective post-cut-off package 130po of the respective side 138s branch other than the respective retained side branch 138r.

The respective side 138s branch other than the respective retained side branch 138r may, for example, be considered to be a respective discarded side branch 138d. The respective post-cut-off package 130po of the respective discarded side branch 138d may, in some examples, be discarded and may hence, by way of example, not be stored in the data store 108, 152.

In some examples, discarding the respective post-cut-off package 130po of the respective discarded side branch 138d may contribute to save resources required for storing the meaningful artifact information packages 130 of the sequence 132 while preserving a meaningful history or branch and inter-branch structure. This may, for example, be the case if the respective discarded side branch 138d is not relevant to the latest package 136 or ongoing and future development of the packages 130 and optionally of the app 120.

By way of example, the respective post-cut-off package 130po of the respective discarded side branch 138d may be deleted in the repository 150 in the context of the suggested management of the artifact information packages 130.

In some examples, the storage size of the sequence 132 of the packages 130 may be reduced to about 33% of the originally required storage size, where a six month cut-off date may be used with respect to the cut-off information 140. Further, in these examples, the overall history structure of the sequence 132 is maintained, for example, by allowing for navigation in the history of the sequence including pre-cut-off packages 130pr, which may be helpful for ongoing and future development of the packages 130 and optionally of the app 120.

According to other approaches, libraries may be used to filter git repositories according to options and filters provided by the developer, such as git-filter-repo. However, such libraries do not have a concept of ‘interesting commits’ (e.g., the above-mentioned interesting side branches 138s or interesting post-cut-off packages 130po) and typically do not reduce the git repository size without losing something of history, branch, and inter-branch structure, commit content, notes tags or files. Typical reductions of git repositories of such other approaches squash commits, which leads to a loss of history and inter-branch and branch structure, filter via git-filter-repo, or prune via garbage collection. Herein, filtering usually affects the whole repository and does not have a concept of the above-mentioned ‘interesting commit’ to preserve. Also, pruning by garbage collection is usually limited to removing orphaned commits or other objects, and does not have criteria for preserving recent history and commits, notes, tags and branch and inter-branch structure, via the above-mentioned ‘interesting’ commits.

Contrary to these other approaches, the suggested management of packages 130 may, for example, use the above-mentioned cut-off period during which, for example, the inter-branch and branch structure may be maintained, along with the commit content, tags, and notes. The suggested method may, for example, use an algorithm employing the above-mentioned concept of ‘interesting commits’ combined with the above-mentioned cut-off date, to decide which commits to discard or prune down (e.g., by removing large blobs). The main advantage of the suggested management of packages 130 may, for example, include that the repository history, branch structure, and inter-branch structures and commit contents and notes may be maintained, at least within the cut-off period, while reducing the git repository size. Further, the suggested management of packages 130 may offer the advantage that the history may be navigable even beyond the cut-off date. According to the suggested management of packages 130, the required storage resource reduction may be achieved well beyond what is possible with a conventional garbage collection. Further, a conventional filtering process may obtain a similar storage resource reduction, but would not have the same quality of preservation as the suggested management of packages 130.

In further examples, the latest package 136 and the respective latest branch package 134s of the respective retained side branch 130r may include at least one head file 142h, respectively, where the application software component 106 and/or the processor 102 may further be configured to: determine the respective head file 142h to be a respective retained file 142r if the latest amendment to the respective head file 142h was stored in one of the pre-cut-off packages 130pr; discard the respective file 142 of the respective pre-cut-off package 130pr other than the respective retained file 142r; and store the respective retained file 142r in the data store 108, 152.

Herein, the respective latest branch package 136s may, for example, be understood as the latest or most recent package 130 of the respective side branch 138s. In some examples, the latest package 136 may include at least one head file 142h that may or may not be stored as a retained file 142r in the data store 108, 152. The decision to store or not to store the head file 142h may, for example, be determined based on when the latest amendment to the head file 142h file was done; in some examples, the cut-off information 140 may be used such that the head file 142h may be stored as a retained file 142r if the head file 142h was stored in one of the pre-cut-off packages 130pr (e.g., before the cut-off 140). In some examples, if the head file 142h was stored in one of the post-cut-off packages 130po (e.g., after the cut-off), the respective head file 142h may be discarded in the respective pre-cut-off package 130pr, which, in some examples, may include the earliest package 134, too. An analogous procedure may, by way of example, be applied to the respective head file 142h of the respective latest branch package 136s.

By way of example, the suggested storage of the respective retained file 142r may be considered to keep the most recent commit relating or of the respective retained file 142r intact throughout the suggested management of the artifact information packages 130. This aspect of the suggested management of the artifact information packages 130 may, for example, correspond to the above-mentioned case of the latest package 136 including artifact information or at least one file that is not amended in the course of the artifact development process and is therefore still relevant to the latest package 136. Hence, in some examples, a meaningful history or branch and inter-branch structure may be preserved, which may be helpful for ongoing and future development of the packages 130 and optionally of the app 120. Further, by discarding the respective file 142 of the respective pre-cut-off package 130pr other than the respective retained file 142r, the fewer data storage resources may be required for storing the relevant aspects of the latest package 136 and of the respective latest branch package 136s of the respective retained side branch 130r.

In further examples, the analogous procedure may be applied only to the head file 142h of the latest package 136 or to the respective head file 142h of the respective latest branch package 136s.

The respective retained file 142r may, for example, be stored in the data store 108, 152; in some examples, the respective retained file 142r may further be stored in the repository 150, for example, replacing the respective head file 142h that was initially stored in the repository 150 and provided to the artifact development platform 118 for the suggested management of the artifact information packages 130.

The respective discarded file 142 of the respective pre-cut-off package 130pr other than the respective retained file 142r may, for example, be deleted in the repository 150 in the context of the suggested management of the artifact information packages 130.

The suggested storage of the respective retained file 142r may, for example, affect to which extent the earliest package 134 and/or the respective pre-cut-off package 130pr is preserved. Conversely, the suggested discard of the respective discarded file 142 of the respective pre-cut-off package 130pr other than the respective retained file 142r may, for example, affect to which extent the earliest package 134 and/or the respective pre-cut-off package 130pr is discarded and, for example, deleted in the repository 150.

Further, in some examples, a short time span related with the cut-off information 140 may, for example, lead to a longer time span for packages 130 to be determined to be pre-cut-off packages 130pr. Hence, the suggested storage of the respective retained file 142r and the suggested discard of the respective discarded file 142 of the respective pre-cut-off package 130pr other than the respective retained file 142r may, for example, have a large impact on how large the data compression and hence how much fewer data storage resources are required for storing the retained elements of the sequence 132.

In FIG. 1, the retained post-cut-off packages 130po of the retained side branches 138r are indicated with “130po-138r”, and the retained post-cut-off packages 130po of the main branch 138r are indicated with “130po-138m”, where the retained post-cut-off packages 130po of the main branch 138r may include the latest package 136.

By way of example, the application software component 106 and/or the processor 102 may further be configured to discard the respective file 142 of respective pre-cut-off package 130pr other than the respective retained file 142r only if the respective storage size exceeds a storage size threshold.

By way of example, the storage size threshold may be configured by the user of the artifact development platform 118, for example, via the artifact development UI 116. In further examples, a default storage size threshold may be defined, for example, to be 32 kB, 256 kB, 2 MB, or 128 MB. The storage size threshold may contribute to keep the suggested management of packages 130 lean and computationally light-weighted so that the procedure may be executed with acceptable computation and memory resource consumption with respect to the artifact development platform's 118 processor 102 and memory 104, while still achieving a valuable reduction of data storage resources that are required for storing the retained elements of the sequence 132.

In further examples, the storage size threshold may be determined depending on the available computation and memory resources so that larger available computation and memory resources may result in a smaller storage size threshold.

In further examples, the application software component 106 and/or the processor 102 may further be configured to store the respective post-cut-off package 130po of the respective retained side branch 138r and of the main branch 138m in the data store 108, 152.

Hence, the post-cut-off packages 130po of the retained side branches 138r and of the main branch 138m may be stored in the data store 108, 152, which contributes to preserve a meaningful history or branch and inter-branch structure that may be helpful for ongoing and future development of the packages 130 and optionally of the app 120. Thanks to the cut-off 140, the data storage resources that are required for storing the retained elements of the sequence 132 may, in some examples, still be reduced significantly during the suggested management of the artifact information packages 130. As already mentioned above, it should be appreciated that, in some examples, the shorter the time span related with the cut-off information 140, the larger the data compression. This provides that fewer data storage resources for storing the retained elements of the sequence 132 are required.

By way of example, the side branches 138s include at least one merged side branch 138m including at least one post-cut-off package 130po, where one of the packages 130 of the main branch 138m may an amended version of the latest package 136m of the merged side branch 138m, and where the application software component 106 and/or the processor 102 may further be configured to determine the respective merged side branch 138m to be one of the retained side branches 138r.

In some examples, the sequence 132 may include a merged side branch 138m that may be a side branch of which the latest branch package 136s may be amended and be integrated into the main branch 138m (or a respective parent branch 130) again. By way of example, the respective merged side branch 138m may be determined to be one of the retained side branches 138r if the respective merged side branch 138m includes at least one post-cut-off package 130po.

Conversely, if the respective merged side branch 138m only includes pre-cut-off packages 130pr (e.g., has been merged into the main branch 138m (or a respective parent branch 130) before the cut-off), this respective merged side branch 138m is, for example, not be determined to be one of the retained side branches 138r.

In further examples, the application software component 106 and/or the processor 102 may further be configured to determine one of the side branches 138s including at least one post-cut-off package 130po to be one of the retained side branches 138r if the respective side branch 138s complies with at least one retention criterion. The at least one retention criterion may include the currentness of the latest package 136s of the respective side branch 138s or a relevance of the respective side branch 138s.

In some examples, a high currentness (e.g., a very recent latest package 136s of the respective side branch 138s) may indicate a comparably high relevance of the latest package 136s of the respective side branch 138s and hence of the respective side branch 138s. Conversely, a low currentness (e.g., a very old latest package 136s of the respective side branch 138s) may indicate a comparably low relevance of the latest package 136s of the respective side branch 138s and hence of the respective side branch 138s.

In further examples, keywords included in the respective side branch 138s or in files included in the respective side branch 138s may indicate a comparably low or high relevance. Keywords indicating a comparably low relevance may, for example, include “test”, “temporary”, “proof of concept” or “poc”, and “temp”. Keywords indicating a comparably high relevance may, for example, include “feature”, “release”, and “fix”. A comparably high relevance of the respective side branch 138s may, in some examples, be given if the respective side branch 138s or the latest package 136s of the respective side branch 138s is similar to the main branch 138m or the latest package 136. Further, a comparably high relevance of the respective side branch 138s may, in some examples, be given if the respective side branch 138s or the latest package 136s of the respective side branch 138s is similar to recent amendments made to the main branch 138m or to the latest package 136. By way of example, the mentioned similarity may be determined using one or more ontologies characterizing the respective side branch 138s or the latest package 136s of the respective side branch 138s on the one hand and the main branch 138m or to the latest package 136 on the other hand. Herein, an ontology may, for example, encompass a representation, formal naming, and definition of the categories, properties, and relations between the concepts, data, and entities that substantiate one, many, or all domains of discourse (e.g., the respective package 130 or the respective branch 138). In general terms and more simply, an ontology may, for example, be a way of showing the properties of a subject area (e.g., the respective package 130 or the respective branch 138) and how the properties are related, by defining a set of concepts and categories that represent the subject. In some examples, the ontology may be a graph so that one element of the ontology may be connected with at least one other element of the ontology, whereby there may be chains of connected elements. In further examples, relevance of the respective side branch 138s may be determined by comparing the respective side branch 138s to user-defined content that the user may provide to the artifact development platform 118 (e.g., via the artifact development UI 116). By way of example, the relevance of the respective side branch 138s to user-defined content may be determined using the above-described concept of ontologies, now characterizing the respective side branch 138s or the latest package 136s of the respective side branch 138s on the one hand and the user-defined content on the other hand.

By way of example, the respective retention criterion may further include information on a maximum allowable number of retained side branches 138r or post-cut-off packages 130po of retained side branches 138r. In such examples, a comparison of available side branches 138s including at least one post-cut-off package 130po may be performed, where the available side branches 138s may be ranked according to their respective accordance with at least one of the retention criteria. Then, in some examples, only the maximum allowable number of top-ranked side branches 138s may be determined to be one of the retained side branches 138r. In other examples, only top-ranked side branches 138s that include at most the maximum allowable number of post-cut-off packages 130po may be determined to be one of the retained side branches 138r.

By way of example, the cut-off information 140 may be determined to be such that a target data storage size of the stored packages 130 is not exceeded and/or that a target compression rate with respect to discarded packages relative to the stored packages 130 is complied with.

By way of example, the target data storage size and/or target compression rate may be configured by the user of the artifact development platform 118 (e.g., via the artifact development UI 116). In further examples, a respective threshold may be defined (e.g., 0.5 GB, 5 GB, 50 GB, or 500 GB with respect to the target data storage size or 40%, 50%, 60%, 70%, 80%, 85%, or 90% with respect to the target compression rate). The target data storage size and/or target compression rate may contribute to keep the suggested management of packages 130 lean and computationally light-weighted so that the procedure may be executed with acceptable computation and memory resource consumption with respect to the artifact development platform's 118 processor 102 and memory 104, while still achieving a valuable reduction of data storage resources that are required for storing the retained elements of the sequence 132.

In further examples, the target data storage size and/or target compression rate may be determined depending on the available computation and memory resources so that larger available computation and memory resources may result in a smaller storage size threshold. In some examples, the target data storage size and/or target compression rate may be determined depending on the available data storage resources for storing the packages 130.

In some examples, the application software component 106 and/or the processor 102 may further be configured to validate storing the stored part of the earliest package 134, and, optionally, of the respective post-cut-off package 130po of the respective retained side branch 138r and of the main branch 138m, in the data store 108, 152.

The storage validation may, for example, validate if the elements of the packages 130 that shall be retained have actually been stored in the data store 108, 152, or, if applicable, been stored again in the repository 150.

In some examples, a file storage validator may be applied for the storage validation. The storage validation may then, for example, include checking if the respective file 142 of the stored part of the earliest package 134, and, optionally, if the respective file 142 of the respective post-cut-off package 130po of the respective retained side branch 138s and of the main branch 138m, is the same in the repository 150 and in the data store 108, 152.

In further examples a commit or package storage validator may be applied for the storage validation. The storage validation may then, for example, include checking if the stored part of the earliest package 134, and, optionally, if the respective post-cut-off package 130po of the respective retained side branch 138s and of the main branch 138m, is the same in the repository 150 and in the data store 108, 152.

In some examples, the storage validation may combine the described file storage validator and package storage validator. By way of example, if one or both of the aspects of the storage validation fail (e.g., at least one element of the packages 130 that shall be retained is not stored in the data store 108, 152), a corresponding message may be communicated to the user of the artifact development platform 118 (e.g., via the artifact development UI 116). In further examples, if one or both of the aspects of the storage validation fail, the storage process of the missing element of the packages 130 that shall be retained may be triggered to be executed (e.g., again).

In further examples, the application software component 106 and/or the processor 102 may further be configured to validate discarding the respective post-cut-off package 130po of the respective side branch 130s other than the respective retained side branch 130r, and, optionally, of the respective file 142 of the respective pre-cut-off package 130pr other than the respective retained file 142r.

The discard validation may, for example, validate if the elements of the packages 130 that shall be discarded or deleted are actually not stored in the data store 108, 152, or, if applicable, have been deleted in the repository 150.

In some examples, a file discard validator may be applied for the discard validation. The discard validation may then, for example, include checking if the respective file 142 of the post-cut-off package 130po of the respective side branch 138s other than the respective retained side branch 138r, and, optionally, if the respective file 142 of the respective pre-cut-off package 130pr other than the respective retained file 142r, is not stored in the data store 108, 152.

In further examples, a commit or package discard validator may be applied for the discard validation. The discard validation may then, for example, include checking if the respective post-cut-off package 130po of the respective side branch 138s other than the respective retained side branch 138r is not stored in the data store 108, 152.

In some examples, the discard validation may combine the described file discard validator and package discard validator. By way of example, if one or both of the aspects of the storage validation fail (e.g., if at least one element of the packages 130 that shall be discarded or deleted is actually stored in the data store 108, 152 (or in the repository 150)), a corresponding message may be communicated to the user of the artifact development platform 118 (e.g., via the artifact development UI 116). In further examples, if one or both of the aspects of the storage validation fail, the discard process with respect to the element of the packages 130 that shall be discarded may be triggered to be executed (e.g., again). The triggered discard process may, for example, include deleting the element of the packages 130 that shall be discarded in the data store 108, 152, and, if applicable, in the repository 150.

In some examples, the respective package 130 may include app information 122 of an app 120 to be developed, where the app information 122 includes a workflow, a model, an input or output interface, a user interface (UI) layout or element, deployment information, metadata, or any combination thereof of the app 122, respectively. The application software component 106 and/or the processor 102 may further be configured to: provide an app development (UI) 116 of an app development platform 118 to a user for developing the app 120; receive user input indicative of an amendment to at least one aspect of the app 120 information via the app development UI 116; amend the app information 122 according to the corresponding user input, where the app information 122 before the amendment corresponds to one of the packages 130, and the amended app information 122′ corresponds to the amended version of this package 130; and develop the app 120 through the app development platform 118 by using the amended app information 122′.

As mentioned above, the artifact development platform 118 may, for example, be an app development platform 118 that provides or includes the above-described functionalities of the development and the creation of the app 120, such as creating the app 120. In some examples, the app development platform 118 may support visual model-based representations, visual model-based apps, and/or visual models and, by way of example, may be a visual model-based app development platform or a low-code app development platform. In some examples, the artifact development UI 116 may correspondingly be an app development UI 116 that may provide an interactive user interface of the app development platform 118 that supports and enables the user to develop the app 120. By way of example, the app 120 may be or include a software pro-gram that, on execution, performs specific desired tasks.

The app 120 to be developed may, for example, be used by an end user for industrial and/or business purposes. An industrial purpose may, for example, be to use the developed app 120 for analyzing, monitoring, controlling, and/or managing an industrial field device or plant including a number of such field devices. The mentioned devices or plants may correspond to a target device that is explained in more detail below. A business purpose may, for example, be to use the developed app 120 for shopping or retail (e.g., to generate or manage customer orders of a hardware or software product). Herein, the app 120 to be developed may, for example, have an app user interface by which the end user of the developed app 120 may interact with the developed app 120 that may run on the end user's device (e.g., the target device 150). For the above-mentioned industrial purposes, the end user of the developed app 120 may, for example, be provided with the latest status data of the monitored field device or plant that may be displayed to the end user via the app UI. In some examples, the end user of the developed app 120 may input queries or commands via the app UI, which may then be transmitted to the connected field device or plant (e.g., to get updated status data or to update control data that is used for controlling the connected field device or plant).

In some examples, the app information 122 includes pieces of information of the app 120 that is currently developed, such as an app workflow, an app model, an app input or output interface, an app user interface (UI) layout or element, app deployment information, app metadata, or any combination. In some examples, app metadata may be stored as ‘git note’ on a commit (e.g., in the app information 122 or the part of the corresponding package 130), which may, for example, enable the app development platform 118 to know which platform version is required to host the app 122.

In this context, developing the app may be collaboratively by a plurality of developers, as already described above in the context of developing the sequence 132 of artifact information packages 130, which may be organized in branches 138. Accordingly, the app information 122 may correspond to one or more of the packages 130 or to one or more parts of the packages 130. By collaboratively developing the app 120 and hence the app information 122, the developers may, for example, create a sequence of pieces of app information 122, where each piece of app information 122 except the earliest piece of app information 122 is an amended version of the respective preceding piece of app information 122, so that the respective app information 122 may, for example, be identified to be at least a part of the respective artifact information package 130. Accordingly, the sequence of pieces of app information 122 may, for example, also include branches, as already explained above in the context of the sequence 132 of artifact information packages 130.

By way of example, the user(s) artifact development platform 118 may provide user input indicative of an amendment to at least one aspect of the app information 122 via the app development UI 116 that is analogous to a corresponding step in the context of context of the sequence 132 of artifact information packages 130. By way of example, the app information 122 may then be amended according to the corresponding user input. The app information 122 before the amendment corresponds to one of the packages 130, and the amended app information 122′ corresponds to the amended version of this package 130.

The app 120 may, for example, be developed through the app development platform 118 by using the amended app information 122′, where the app development platform 118 may, for example, support the above-mentioned visual model-based app development that may provide the user of the app development platform 118 with the developed app 120 based on the amended app information 122′ (and optionally further input provided by the user in the course of the development of the app 120). The developed app 120 may, for example, be adapted to the mentioned target platform on which the developed app 120 is to be deployed and run. In some examples, the user of the app development platform 118 may select the respective target platform, and the app development platform 118 prepares a respective version of the developed app 120 that is suitable for deployment and run on the respective target platform.

In an example embodiment, the app 120 may be deployed on a respective target device 150. In some examples, the respective target device may be physically connected or communicatively connected to another device or connected, such that the respective target device may at least detect input data from the other device (e.g., by optically inspecting the other device). The respective target device and/or the other device may, in some examples, be or include a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The respective target device may be part of a complex production line or production plant (e.g., a bottle filing machine, conveyor, welding machine, welding robot, etc.). In some examples, if the other device belongs to a lower level of the automation pyramid, such as the sensor/actuator or the field level, then the respective target device may belong to a higher level of the automation pyramid, such as field level or the control level.

In further examples, the application software component 106 and/or the processor 102 may further be configured to: receive user input indicative of merging at least one of the retained files 142r and/or at least one of the packages 130 of one of the retained side branches 138r into the main branch 138m via the app development UI 116; create a new package 130n by amending the latest package 136 to incorporate the respective retained file 142r and/or the respective package 130 to be merged into the main branch 138m according to the corresponding user input; store the new package 130n in the data store 108, 152; and develop the app 120 through the app development platform 118 by using the new package 130n.

The merge action indicated by the user may, for example, imply the developer to move the development of the sequence 132 or of the app 120 by using at least a part of an earlier commit or package 130 or of one of the retained side branches 138r and by merging the mentioned part or package 130 into the main branch 138m. Hence, the user may, for example, benefit from the preserved, meaningful recent history or branch and inter-branch structure for the user's ongoing and future development of the packages 130 and optionally of the app 120. This benefit may, for example, be achieved thanks to the suggested management of packages 130 while reducing the data storage resources required for storing the retained elements of the sequence 132.

The merge action indicated by the user may, for example, be used to create new package 130n, which reflects the merge of the mentioned part or package 130 into the latest package 136 that is part of the main branch 138m. The new package 130n may then be stored, for example, in the data store 108, 152 and optionally in the repository 150. In further examples, the app 120 may then be developed, as already mentioned above, through the app development platform 118 using the new package 130n so that also the developed app 120 benefit from the preserved, meaningful recent history or branch and inter-branch structure.

By way of example, the application software component 106 and/or the processor 102 may further be configured to: receive user input indicative of amending a selected package 130s of one of the retained side branches 138r; create a further package 130f by amending the selected package 130s according to the corresponding user input; determine the retained side branch 138r including the selected package 130s and the created further package 130f to be a new main branch 138nm; store the new main branch 138nm in the data store 108, 152; and develop the app 120 through the app development platform 118 by using the further package 130f and the new main branch 138nm.

The amendment of the selected package 130s and the creation of the further package 130f as an amended, selected package 130s may, for example, be of value if a customer of the user still uses an older version of the app 120 and requires a fix or a batch of the older version of the app 120. The mentioned fix or batch may, for example, focus on required improvements to the older version of the app 120, for example, to adequately handle a discovered vulnerability of older version of the app 120. In some examples, the most recent, regular version of the app 120 does (no more) have the mentioned vulnerability (e.g., because the corresponding feature of the older app 120 has been deleted or otherwise been amended). Hence, the user may, for example, benefit from the preserved, meaningful recent history or branch and inter-branch structure for the user's ongoing and future development of the packages 130 and optionally of the older version of the app 120. This benefit may, for example, be achieved thanks to the suggested management of packages 130 while reducing the data storage resources required for storing the retained elements of the sequence 132.

In such fix or batch scenarios of older versions of the app 120, the new main branch 138nm may, for example, be established based on the retained side branch 138r including the selected package 130s and the created further package 130f. The new main branch 138nm may then be stored, for example, in the data store 108, 152 and optionally in the repository 150. In further examples, the app 120 (e.g., a fixed or batched version of the older version of the app 120) may then be developed, as already mentioned above, through the app development platform 118 using the new main branch 138nm including the further package 130f so that also this version of the developed app 120 benefit from the preserved, meaningful recent history or branch and inter-branch structure.

Generally, it should be appreciated that in some examples, the suggested management of packages 130, such as packages 130 relating to different development branches 138 of an app 120, may offer various benefits including the support of multiple branches during the software development. In some examples, the preservation of merge commits or packages 130 may be achieved which may, for example, help to preserve the overall historical structure. Further, the full history up to the cut-off date (e.g., from the present back to the cut-off date) may, by way of example, be achieved. The suggested management of packages 130 may, for example, be run repeatedly (e.g., using a suitable config file) until desired a result is obtained. This may, in some examples, include the above-mentioned thresholds or target data storage (e.g., target compression rate). Further, the suggested management of packages 130 may, for example, be offered to the user using a friendly wizard text-based interface (e.g., via the artifact development UI 116 or the app development UI 116).

In some examples, when the suggested management of packages 130 has been completed (e.g., by the artifact development platform 118 or the app development platform 118), the pruned or cleaned sequence 132 may be stored in the repository 150 (e.g., replacing an earlier version of the sequence 132 and thus requiring less data storage resources in the repository 150). In further examples, after the results of the cleanup are pushed to the repository, all local clones may be reset so that the pruned or cleaned sequence 132 may, for example, replace an earlier version of the sequence 132 in the repository 150 and on local data stores in which clones may be stored. By way of example, this may imply that each developer of the team who has the project on disk and CI (Continuous Integration) pipelines that have cached data may get a fresh clone. In some examples, before storing the fresh clone (e.g., the pruned or cleaned sequence 132) on the developer's local data store, the developer's not yet committed (e.g., not yet centrally stored) work or packages 130 may be stored in a separate data store that may not be affected by the above-described discard or deletion steps to avoid undesired data losses. The developer may then, for example, merge the not yet committed work or packages 130 into the fresh clone (e.g., the pruned or cleaned sequence 132).

The application software component 106 and/or the processor 102 may carry out an analogous method of managing artifact information packages 130, such as packages 130 relating to different development branches 138 of an app 120. Further, a computer-readable medium 160 that may include a computer program product 162 is shown in FIG. 1. The computer program product 162 may be encoded with executable instructions that, when executed, cause the computer system 100 and/or the app development platform 118 to carry out the described method.

Further, the app 120 may be understood as deployed if the activities that are required to make this app 120 available for use by the app end user on the respective target device are completed. The app deployment process may include a number of interrelated activities with possible transitions between the interrelated activities. These activities may occur at the producer side (e.g., by the app developer) or at the consumer side (e.g., by the app user or end user) or both. In some examples, the app deployment process may include at least the release of the app 120 and the installation and the activation of the app 120. The release activity may follow from the completed development process and is sometimes classified as part of the development process rather than deployment process. The release activity may include operations required to prepare a system (e.g., the app development platform 118 or an online app store) for assembly and transfer to the computer system(s) (e.g., the respective target device) on which the release activity will be run in production. Therefore, the release activity may sometimes involve determining the resources required for the system to operate with tolerable performance and planning and/or documenting subsequent activities of the deployment process. For simple systems, the installation of the app 120 may involve establishing some form of command, shortcut, script, or service for executing the software (e.g., manually or automatically) of the app 120. For complex systems, the installation of the app 120 may involve configuration of the system (e.g., possibly by asking the end user questions about the intended app use, or directly asking the end user how the end user would like it to be configured) and/or making all the required subsystems ready to use. Activation may be the activity of starting up the executable component of software or the app 120 for the first time (e.g., which is not to be confused with the common use of the term activation concerning a software license, which is a function of Digital Rights Management systems).

FIG. 2 depicts a flow diagram of an example software development process including different branches 138 with artifact information packages 130 that are managed by the first example system 100.

The sequence 132 of packages 130 includes an earliest package 134 and a latest package 136 that define the main branch 138m. The cut-off 140 separates the packages 130 in pre-cut-off packages 130pr and post-cut-off packages 130po. At the second pre-cut-off package 130pr of the main branch 138m, a first side branch 138s (e.g., in FIG. 2, the side branch 138s below the main branch 138m) is branched off the main branch 138m. This first side branch 138s is later merged back into main branch 138m, so that the first side branch 138s is also a merged side branch 138me and a retained side branch 138r. At the first pre-cut-off package 130pr of the first side branch 138s, a second side branch 138s (e.g., in FIG. 2, the bottom side branch 138s) is branched off and discarded. At the third pre-cut-off package 130pr of the main branch 138m, a third side branch 138s (e.g., in FIG. 2, the top side branch 138s) is branched off the main branch 138m and retained.

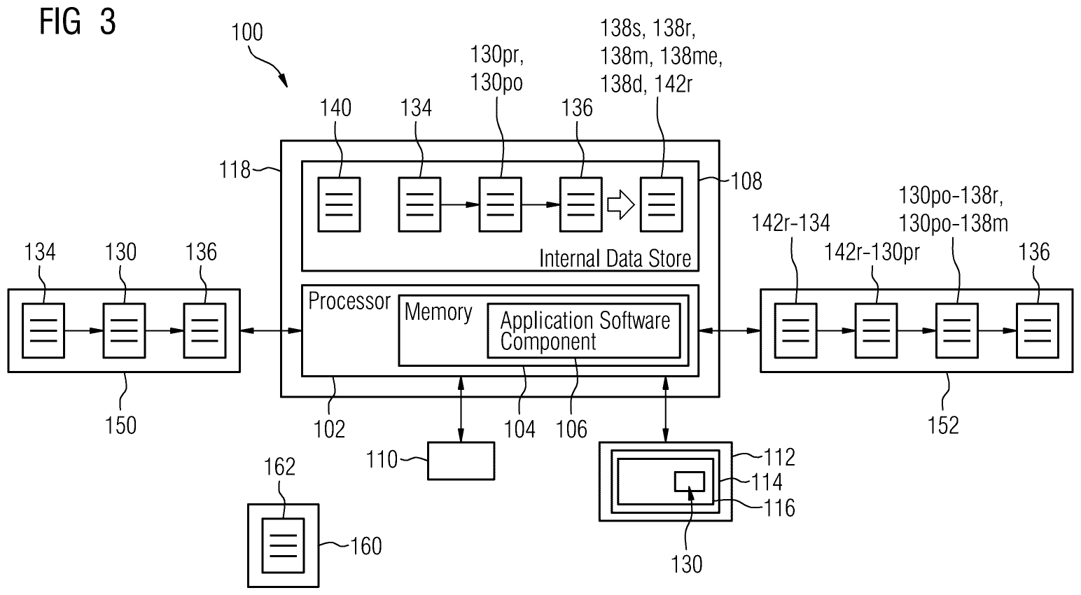

FIG. 3 depicts a functional block diagram of a second example system 100 that facilitates managing artifact information packages 130 in a product system.

The second example system 100 is capable of determining and storing a respective retained file 142 of the earliest package 134, which is indicated by “142r-134”, and of determining and storing a respective retained file 142 of the respective pre-cut-off package 130pr, which is indicated by “142r-130pr”. These aspects are explained in more details above.

While the respective retained file 142 of the earliest package 134 (“142r-134”), the respective retained file 142 of the respective pre-cut-off package 130pr (“142r-130pr”), the retained post-cut-off packages 130po of the retained side branches 138r (“130po-138r”), the retained post-cut-off packages 130po of the main branch 138r (“130po-138m”), and the latest package 136 may be stored in the repository 150, the other packages 130 or not retained files 142 may be discarded and hence not be stored or even be deleted in the repository 150.

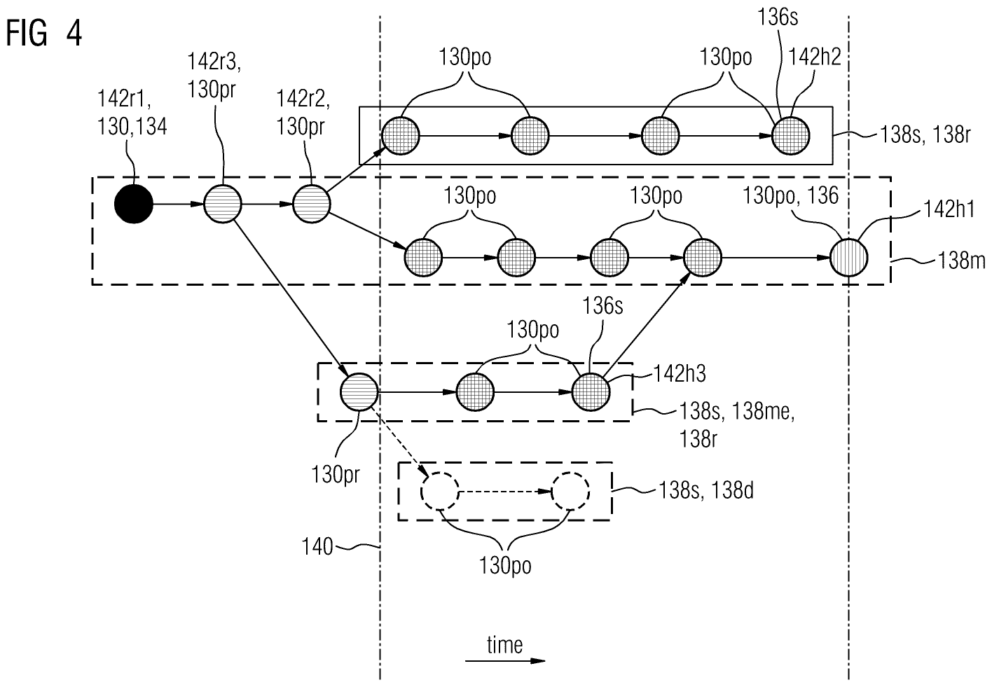

FIG. 4 depicts a flow diagram of another example software development process including different branches 138 with artifact information packages 130 that are managed by the second example system 100.

The sequence 132 is similar to the one depicted in FIG. 2 and explained above. The latest package 136 includes a head file 142h1 that has not been amended since the earliest package 134 that includes the head file 142h1 as retained file 142r1. Accordingly, the retained file 142rl of the earliest package 134 is retained and stored (e.g., in the repository 150).

The latest branch package 136s of the third side branch 138s (e.g., in FIG. 4, the top side branch 138s) includes a head file 142h2 that has not been amended since the third pre-cut-off package 130pr of the main branch 138m that includes the head file 142h2 as retained file 142r2. Accordingly, the retained file 142r2 of the third pre-cut-off package 130pr of the main branch 138m is retained and stored, for example, in the repository 150.

The latest branch package 136s of the first side branch 138s (e.g., in FIG. 4, the side branch 138s below the main branch 138m) includes a head file 142h3 that has not been amended since the second pre-cut-off package 130pr of the main branch 138m that includes the head file 142h3 as retained file 142r3. Accordingly, the retained file 142r3 of the second pre-cut-off package 130pr of the main branch 138m is retained and stored, for example, in the repository 150.

Assuming that the above-mentioned head file 142h2 or head file 142h3 was amended after the cut-off 140, no corresponding file 142 of one of the pre-cut-off packages 130pr or of the earliest package 134 would be stored. Rather, in some examples, corresponding file 142 of one of the pre-cut-off packages 130pr or of the earliest package 134 may be discarded or even be deleted (e.g., in the repository 150).

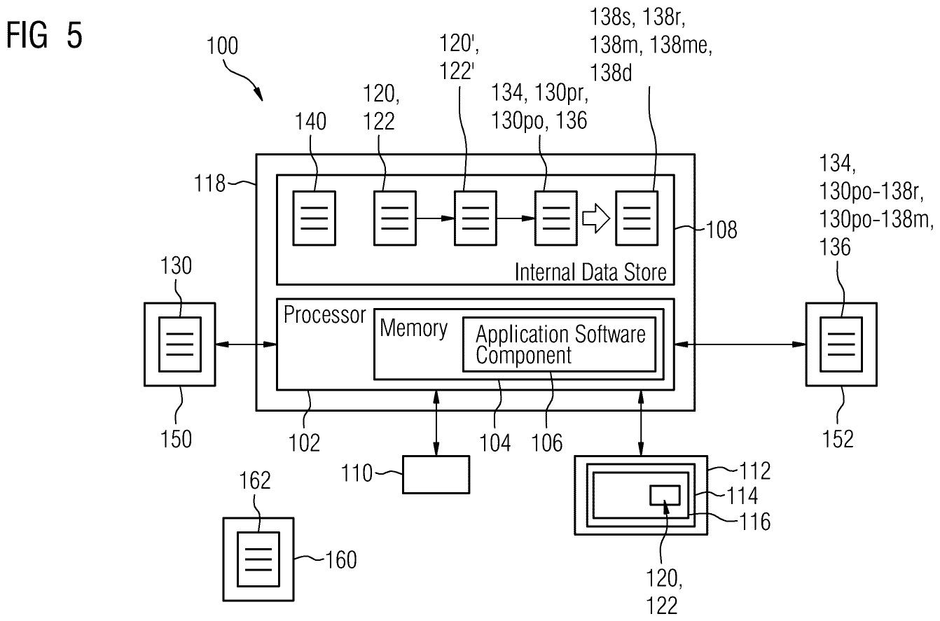

FIG. 5 depicts a functional block diagram of a third example system 100 that facilitates app development and managing artifact information packages 130 in a product system.

The second example system 100 includes the app development platform 118 that may support developing the app 120 and managing app information 122 and amended app information 122′ as described above.

While the earliest package 134, the retained post-cut-off packages 130po of the retained side branches 138r (“130po-138r”), the retained post-cut-off packages 130po of the main branch 138r (“130po-138m”), and the latest package 136 may be stored in the repository 150, the other packages 130 or not retained files 142 may be discarded and hence not be stored or even be deleted in the repository 150. Further, the developed app 120 (e.g., in its entirety) may optionally also be stored in the repository 150.

In some examples, only respective retained file 142 of the earliest package 134 (“142r-134”) may be stored in the repository 150, whereas other files of the earliest package 134 may be discarded and hence not be stored or even be deleted in the repository 150. In further examples, the respective retained file 142 of the respective pre-cut-off package 130pr (“142r-130pr”) may be stored in the repository 150, whereas the other packages 130 or not retained files 142 may be discarded and hence not be stored or even be deleted in the repository 150.

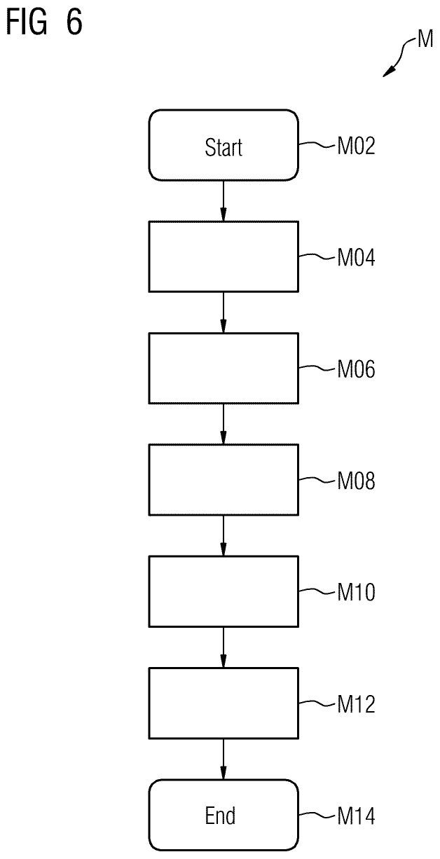

Referring now to FIG. 6, a methodology M that facilitates managing of artifact information packages, such as packages relating to different development branches of an app, in a product system, is shown. The methodology M may start at M02, and the methodology M may include a number of acts carried out through operation of at least one processor.

These acts may include an act M04 of providing a sequence of artifact information packages including an earliest package and a latest package in a data repository, where each package except the earliest package is an amended version of the respective preceding package. The sequence further includes at least three branches of packages including a main branch. The main branch includes the latest package. The branches further include at least two side branches of which a respective earliest branch package is a respective amended version of a preceding package of the main branch. An act M06 includes providing cut-off information separating the packages in pre-cut-off packages and post-cut-off packages. An act M08 includes determining at least one of the side branches including at least one post-cut-off package to be a respective retained side branch. An act M10 includes storing at least a part of the earliest package in a data store, and an act M12 includes discarding the respective post-cut-off package of the respective side branch other than the respective retained side branch. At M14, the methodology may end.

The methodology M may include other acts and features discussed previously with respect to the computer-implemented method of managing of artifact information packages, such as packages relating to different development branches of an app.

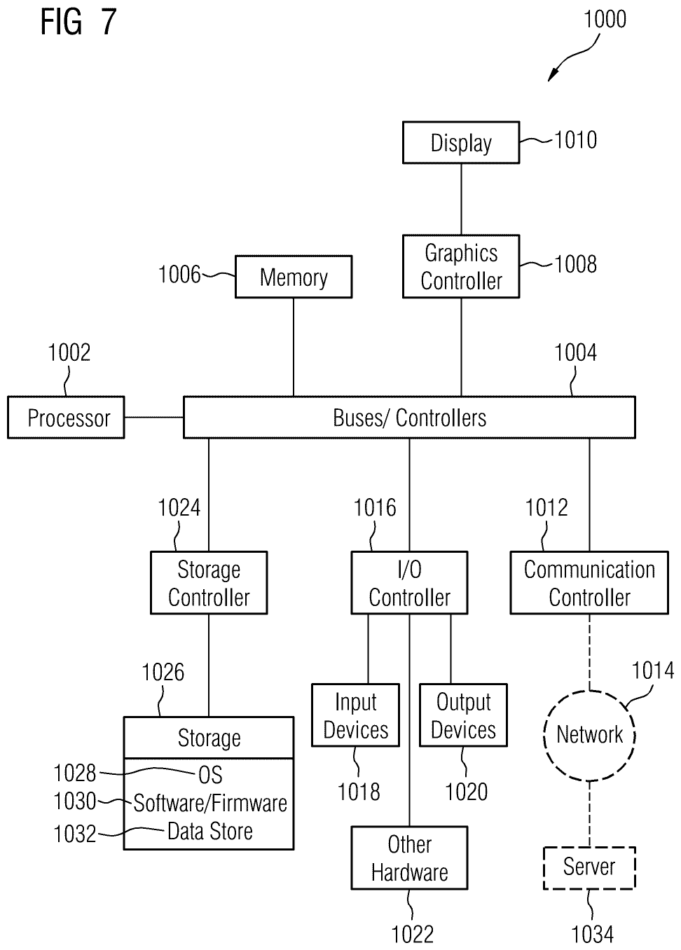

FIG. 7 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. In some embodiments, one or more controllers (e.g., graphics, south bridge) may be integrated with the CPU (e.g., on the same chip or die). Examples of CPU architectures include IA-32, x86-64, and ARM processor architectures.

Other peripherals connected to one or more buses may include communication controllers 1012 (e.g., Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (e.g., connected to speakers and/or microphones). Various peripherals may be connected to the I/O controller(s) (e.g., via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers), or any other type of device that is operative to provide inputs to or receive outputs from the data processing system. Also, many devices referred to as input devices or output devices may both provide inputs and receive outputs of communications with the data processing system. For example, the processor 1002 may be integrated into a housing (e.g., a tablet) that includes a touch screen that serves as both an input and display device. Further, some input devices (e.g., a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMS, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (e.g., that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed, and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 1012 may be connected to the network 1014 (e.g., not a part of data processing system 1000), which may be any public or private data processing system network or combination of networks, as known to those of skill in the art, including the Internet. Data processing system 1000 may communicate over the network 1014 with one or more other data processing systems such as a server 1034 (e.g., also not part of the data processing system 1000). However, an alternative data processing system may correspond to a plurality of data processing systems implemented as part of a distributed system in which processors associated with a number of data processing systems may be in communication via one or more network connections and may collectively perform tasks described as being performed by a single data processing system. Thus, it is to be understood that when referring to a data processing system, such a system may be implemented across a number of data processing systems organized in a distributed system in communication with each other via a network.

Further, the term “controller” may be any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be included in a client device that communicates with the server (e.g., and/or a virtual machine executing on the server) through a wired or wireless network (e.g., which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCOIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across a number of devices.

Also, as used herein, a processor corresponds to any electronic device that is configured via hardware circuits, software, and/or firmware to process data. For example, processors described herein may correspond to one or more (e.g., or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “include,” as well as derivatives thereof, provide inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, providing and/or, unless the context clearly indicates otherwise. The phrases “associated with” and “associated therewith,” as well as derivatives thereof, may be to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather, these numeral adjectives are used to distinguish different elements, functions, or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may be that the processor is operatively configured to or operably configured to carry out the functions or processes via software, firmware, and/or wired circuits. For example, a processor that is configured to carry out a function/process may correspond to a processor that is executing the software/firmware that is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes may also correspond to a processor circuit particularly fabricated or “wired” to carry out the functions or processes (e.g., an ASIC or FPGA design). Further, the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may provide: that an element is relatively near to but not in contact with a further element; or that the element is in contact with the further portion, unless the context clearly indicates otherwise.

Although embodiments of the present disclosure have been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be included in the claim scope: the scope of patented subject matter is defined only by the allowed claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method comprising:
providing a sequence of artifact information packages including an earliest package and a latest package in a data repository, wherein each package of the sequence of artifact information packages except the earliest package is an amended version of the respective preceding package, wherein the sequence of artifact information packages further includes at least three branches of packages including a main branch, the main branch including the latest package, and wherein the at least three branches of packages further include at least two side branches of which a respective earliest branch package is a respective amended version of a preceding package of the main branch;
providing cut-off information separating the sequence of artifact information packages in pre-cut-off packages and post-cut-off packages;
determining at least one of the at least two side branches including at least one of the post-cut-off packages to be a respective retained side branch;
storing at least a part of the earliest package in a data store; and
discarding the respective post-cut-off package of the respective side branch other than the respective retained side branch.

2. The computer-implemented method of claim 1, wherein the latest package and the respective latest branch package of the respective retained side branch includes at least one head file, respectively,
wherein the computer-implemented method further comprises:
determining the respective head file to be a respective retained file when the latest amendment to the respective head file was stored in one of the pre-cut-off packages;
discarding a respective file of the respective pre-cut-off package other than the respective retained file; and
storing the respective retained file in the data store.

3. The computer-implemented method of claim 2, further comprising:
discarding the respective file of respective pre-cut-off package other than the respective retained file only when a respective storage size exceeds a storage size threshold.

4. The computer-implemented method of claim 1, further comprising:
storing the respective post-cut-off package of the respective retained side branch and of the main branch in the data store.

5. The computer-implemented method of claim 1, wherein the at least two side branches include at least one merged side branch including at least one post-cut-off package,
wherein one package of the sequence of artifact information packages of the main branch is an amended version of the latest package of the at least one merged side branch,
wherein the computer-implemented method further comprises:
determining the respective merged side branch to be one of the retained side branches.

6. The computer-implemented method of claim 1, further comprising:
determining one of the at least two side branches including at least one post-cut-off package to be one of the retained side branches when the respective side branch complies with at least one retention criterion,
wherein the at least one retention criterion includes currentness of the latest package of the respective side branch or a relevance of the respective side branch.

7. The computer-implemented method of claim 1, wherein the cut-off information is determined to be such that:
a target data storage size of stored packages is not exceeded;
a target compression rate with respect to discarded packages relative to the stored packages is complied with; or
a combination thereof.

8. The computer-implemented method of claim 1, further comprising:
validating storing the stored part of the earliest package in the data store,
wherein:
the storage validation includes checking whether the respective file of the stored part of the earliest package is the same in the repository and in the data store;
the storage validation includes checking whether the stored part of the earliest package is the same in the repository and in the data store; or
a combination thereof.

9. The computer-implemented method of claim 8, further comprising:
validating storing a stored part of the respective post-cut-off package of the respective retained side branch and of the main branch,
wherein:
the storage validation includes checking whether the respective file of the respective post-cut-off package of the respective retained side branch and of the main branch is the same in the repository and in the data store;
the storage validation includes checking whether the stored part of the respective post-cut-off package of the respective retained side branch and of the main branch is the same in the repository and in the data store; or
a combination thereof.

10. The computer-implemented method of claim 1, further comprising:
validating discarding the respective post-cut-off package of the respective side branch other than the respective retained side branch,
wherein:
the discard validation includes checking whether the respective file of the post-cut-off package of the respective side branch other than the respective retained side branch is not stored in the data store;
the discard validation includes checking whether the respective post-cut-off package of the respective side branch other than the respective retained side branch is not stored in the data store; or
a combination thereof.

11. The computer-implemented method of claim 10, further comprising:
validating discarding of the respective file of the respective pre-cut-off package other than the respective retained file,
wherein the discard validation includes checking whether the respective file of the respective pre-cut-off package other than the respective retained file is not stored in the data store.

12. The computer-implemented method of claim 1, wherein the respective package includes app information of an app to be developed,
wherein the app information includes a workflow, a model, an input or output interface, a user interface (UI) layout or element, deployment information, metadata, or any combination thereof of the app, respectively, and
wherein the method further comprises:
providing an app development UI of an app development platform to a user for developing the app;
receiving user input indicative of an amendment to at least one aspect of the app information via the app development UI;
amending the app information according to the user input, wherein the app information before the amendment corresponds to one package of the sequence of artifact information packages, and the amended app information corresponds to the amended version of this package; and
developing the app through the app development platform using the amended app information.

13. The computer-implemented method of claim 12, further comprising:
receiving user input indicative of merging at least one of the retained files, at least one of the packages of one of the retained side branches, or the at least one retained file and the at least one package of the one retained side branch into the main branch via the app development UI;
creating a new package, the creating of the new package comprising amending the latest package to incorporate the respective retained file, the respective package to be merged into the main branch, or the latest package to incorporate the respective retained file and the respective package to be merged into the main branch according to the corresponding user input;
storing the new package in the data store; and
developing the app through the app development platform using the new package.

14. The computer-implemented method of claim 12, further comprising:
receiving user input indicative of amending a selected package of one of the retained side branches;
creating a further package, the creating of the further package comprising amending the selected package according to the corresponding user input;
determining this retained side branch including the selected package and the created further package to be a new main branch;
storing the new main branch in the data store; and
developing the app through the app development platform using the further package and the new main branch.

15. A computer system comprising:
a processor configured to:
provide a sequence of artifact information packages including an earliest package and a latest package in a data repository, wherein each package of the sequence of artifact information packages except the earliest package is an amended version of the respective preceding package, wherein the sequence of artifact information packages further includes at least three branches of packages including a main branch, the main branch including the latest package, and wherein the at least three branches of packages further include at least two side branches of which a respective earliest branch package is a respective amended version of a preceding package of the main branch;
provide cut-off information separating the sequence of artifact information packages in pre-cut-off packages and post-cut-off packages;
determine at least one of the at least two side branches including at least one of the post-cut-off packages to be a respective retained side branch;
store at least a part of the earliest package in a data store; and
discard the respective post-cut-off package of the respective side branch other than the respective retained side branch.

16. A computer program product comprising:
computer program code that, when executed by a computer system, cause the computer system to:
provide a sequence of artifact information packages including an earliest package and a latest package in a data repository, wherein each package of the sequence of artifact information packages except the earliest package is an amended version of the respective preceding package, wherein the sequence of artifact information packages further includes at least three branches of packages including a main branch, the main branch including the latest package, and wherein the at least three branches of packages further include at least two side branches of which a respective earliest branch package is a respective amended version of a preceding package of the main branch;
provide cut-off information separating the sequence of artifact information packages in pre-cut-off packages and post-cut-off packages;
determine at least one of the at least two side branches including at least one of the post-cut-off packages to be a respective retained side branch;
store at least a part of the earliest package in a data store; and
discard the respective post-cut-off package of the respective side branch other than the respective retained side branch.

17. A non-transitory computer-readable storage medium that stores instructions executable by a computer system, the instructions comprising:
providing a sequence of artifact information packages including an earliest package and a latest package in a data repository, wherein each package of the sequence of artifact information packages except the earliest package is an amended version of the respective preceding package, wherein the sequence of artifact information packages further includes at least three branches of packages including a main branch, the main branch including the latest package, and wherein the at least three branches of packages further include at least two side branches of which a respective earliest branch package is a respective amended version of a preceding package of the main branch;
providing cut-off information separating the sequence of artifact information packages in pre-cut-off packages and post-cut-off packages;
determining at least one of the at least two side branches including at least one of the post-cut-off packages to be a respective retained side branch;
storing at least a part of the earliest package in a data store; and
discarding the respective post-cut-off package of the respective side branch other than the respective retained side branch.
